(19) United States
(12) Patent Application Publication
(10) Pub. No.: US 2026/0366937 A1
(43) Pub. Date: Nov. 19, 2026

(54) WIRE STRAND, TENSIONING CABLE, GEOTECHNICAL ANCHOR AND CONCRETE STRUCTURE

(71) Applicant: DYWIDAG-Systems International GmbH, Unterschleissheim (DE)

(72) Inventors: Christian GLÄSER, Unterschleissheim (DE); Benedikt HEGMANN, Unterschleissheim (DE); Matthias WILD, Unterschleissheim (DE); Felix FÖRSTER, Unterschleissheim (DE)

(21) Appl. No.: 19/132,436

(22) PCT Filed: Aug. 6, 2024
(86) PCT No.: PCT/EP2024/072225

§ 371 Date: May 23, 2025

(30) Foreign Application Priority Data
Aug. 10, 2023 (EP) 23190774.2

(51) Int. Cl. G01L 5/105; G01M 5/00; G01M 11/08

(52) U.S. Cl. CPC G01L 5/105; G01M 5/0058; G01M 11/086

(57) ABSTRACT

A wire strand includes at least three wires. An optical fiber is arranged in a cavity between three adjacent ones of the at least three wires. The optical fiber includes a fiber core and at least one further layer surrounding the fiber core. The diameter of the largest imaginary circle inscribable in the cross-section of the cavity is smaller than the outer diameter of the optical fiber. The diameter of the fiber core is smaller than the diameter of the largest imaginary circle, and the ratio of the outer diameter of the optical fiber to the diameter of that one of the three adjacent wires which has the smallest diameter is at least about 0.15 and at most about 0.18.

### FIELD OF THE INVENTION

The invention relates to the field of monitoring the condition of a concrete structure, in particular concrete structures in bonded and unbonded systems in building and infrastructure as well as geotechnical applications.

In the case of concrete structures made of pre-stressed concrete, the tensioning elements, in particular tensioning cables, are embedded directly in the concrete of the structure, whereas the connection between the tensioning elements and the concrete in the case of structures made of post-tensioned concrete is only brought about subsequently by grouting with cementitious grout. As a result of the direct or indirect connection of the tensioning elements with the concrete, the incremental strain in the tensioning elements gets consistent with the concrete strain. As the pre-stressing or post-tensioning forces, respectively, can locally vary within the tendon length whilst the force at the anchorages remain unchanged, it is not possible to measure the pre-stressing or post-tensioning forces, respectively, with typical measurement systems at the anchorages. For this reason, measurement systems including optical fibers exiting at the anchorages have been developed.

The invention may, however, also be applied to unbonded tensioning elements, as well as geotechnical strand anchors and the like.

### TECHNOLOGICAL BACKGROUND

With the aim of being able to monitor the condition of a concrete structure, U.S. Pat. No. 9,575,271 B2 discloses a tensioning cable with an optical fiber embedded therein. The optical fiber runs between the strands of the tensioning cable formed from these strands. Each of the strands in turn comprises a plurality of wires which are helically twisted together. Although the strands may be protected by a sheath, for example made of PE (polyethylene), they have an irregular and uneven surface due to the helical twisting of the wires. Thus, the optical fiber lies against the irregular and uneven surface of the strands. The resulting clamping force, which consequently varies in the longitudinal direction of the tensioning cable, makes the interpretation of the measurement results obtained by means of the optical fiber considerably more difficult.

### SUMMARY OF THE INVENTION

It is therefore the object of the present invention to provide a solution to this problem.

According to the invention, this object is solved by a wire strand comprising at least three wires, wherein an optical fiber is arranged in a cavity between three adjacent ones of the at least three wires, which optical fiber comprises a fiber core and at least one further layer surrounding the fiber core, wherein the diameter of the largest imaginary circle inscribable in the cross-section of the cavity is smaller than the outer diameter of the optical fiber, wherein the diameter of the fiber core is smaller than the diameter of said largest imaginary circle, and wherein the ratio of the outer diameter of the optical fiber to the diameter of that one of the three adjacent wires which has the smallest diameter is at least 0.15 and at most 0.18.

Due to the fact that, according to the invention, the optical fiber is arranged in the tensioning strand, it is in contact with a longitudinally substantially uniform surface, namely the surface of the three adjacent wires of the tensioning strand forming the cavity, which extends substantially uniformly in the longitudinal direction of the tensioning strand, thus providing longitudinally uniform conditions for measurements. Since the diameter of the imaginary circle inscribed in the cross-section of the cavity (in the following also referred to as “cavity circle”) is smaller than the outer diameter of the optical fiber, the optical fiber can be held in the cavity purely by clamping force. The additional use of adhesives is not required. Additional measures for fixing the optical fiber in the tensioning strand are not required. At the same time, the optical fiber is protected by the outer wires of the strand. Furthermore, since the diameter of the fiber core is smaller than the diameter of the cavity circle, there is no risk of damage to the fiber core, which is important for measurements. At the same time, however, the fiber core is mechanically coupled to the wires of the strand to a degree that enables meaningful measurements if the ratio of the outer diameter of the optical fiber to the diameter of that one of the three adjacent wires that has the smallest diameter is at least about 0.15 and at most about 0.18, preferably at least about 0.16 and at most about 0.17, more preferably at least about 0.163 and at most about 0.169.

The wire strand according to the present invention, and in particular the optical fiber included therein, allows to measure the strain in a locally resolved manner, i.e. resolved along the length of the wire strand. The measurements may be carried out based on both Brillouin or Rayleigh radiation.

In the case of pre-stressed and/or post-tensioned concrete structures the locally resolved measurement allows to localize the position of possibly critical parts of the concrete structure. In geotechnical applications this is also true for the bonded length of the anchor. In unbonded applications at least the overall behavior of the tensioning element between its anchorages can be detected. And the same is true for the free length of geotechnical strand anchors.

In addition, it is to be noted that the invention further allows to monitor the strain of the tensioning element during the initial tensioning of the same.

Advantageously, the Young's modulus of the material from which the at least one further layer is formed may amount to between about 1,000 MPa and about 210,000 MPa.

For example, at least one of the at least one further layers surrounding the fiber core may be formed from a polyacrylate.

Additionally or alternatively, at least one of the at least one further layer surrounding the fiber core, preferably the radially outermost layer of the optical fiber, may be formed of metal, preferably steel.

In order to be able to prevent a harmful influence of the metal layer on the steel of the tension wires, it is proposed, that the standard potential of the metal of the at least one further layer surrounding the fiber core is lower than or equal to the standard potential of the wires of the strand. Here, the standard potential is the electrochemical potential, the value of which provides information about the ability of the metal to accept electrons.

In a further development of the invention, it is proposed that the wire strand comprises a center wire and a plurality of outer wires, preferably helically wound around the center wire, wherein at least six of the outer wires are contacting the center wire. Typically, a wire strand used in connection with the present invention may comprise a center wire surrounded by six outer wires. Such a strand has at least six cavities around the center wire in which optical fibers can be disposed. The diameter of the center wire can be up to 3% larger than the diameter of the outer wires.

For such a wire strand it is further suggested that a further optical fiber may be arranged in a further cavity formed by the center wire and two adjacent outer wires, at least one further layer surrounding the fiber core of the further optical fiber being formed by a gel. In this way, even if the further optical fiber additionally also has a cladding layer, for example formed of metal, mechanical decoupling between the fiber core and the cladding or the wires of the stranded wire can be ensured, so that the further optical fiber can be used, for example, as a temperature sensor. Such a temperature sensor can facilitate the evaluation of the measurement signals originating from the first optical fiber. It is to be understood that the outer diameter of the further optical fiber can be smaller than the diameter of the cavity circle.

It should be added that the aforementioned optical fibers have, on the one hand, the advantage of alkali resistance, which is important with respect to the cement contained in the concrete, and, on the other hand, the advantage of a service life that usually exceeds the service life of the building structure, so that the condition of the building structure can be monitored even toward the end of the service life of the building structure.

A tensioning strand of the type mentioned above is neither anticipated by the aforementioned U.S. Pat. No. 9,575,271 B2 nor by any other prior art document. EP 3,805,726 A1 discloses a measuring system comprising an optical fiber, but deals almost exclusively with metrological aspects. The optical fiber known from U.S. Pat. No. 5,026,141 runs in a straight line on the outer surface of a pipeline.

Similarly, the optical fiber known from U.S. Pat. No. 5,841,139 runs on a frame embedded in concrete.

According to a second aspect, the present invention relates to a tensioning cable including at least one wire strand according to the present invention.

According to a third aspect, the present invention relates to a concrete structure including at least one wire strand according to the present invention or at least one tensioning cable according to the present invention, said concrete building structure preferably being made from pre-stressed concrete and/or post-tensioned concrete.

### BRIEF DESCRIPTION OF THE DRAWINGS

In the following the invention will be explained in more detail referring to the attached drawings, in which

FIG. 1 shows a schematic cross-section of a wire strand according to the invention;

FIG. 2 shows a schematic cross-section of an exemplary embodiment of an optical fiber as can be used in the context of the invention;

FIG. 3 shows a schematic representation of a pre-stressed concrete structure according to the invention;

FIG. 4 shows a schematic representation of a post-tensioned concrete structure according to the invention;

FIG. 5 a schematic representation of an unbonded concrete structure according to the invention; and

FIG. 6 shows a schematic representation of a geotechnical strand anchor according to the invention.

### DETAILLED DESCRIPTION OF AN EMBODIMENT

In FIG. 1, a wire strand according to the invention is generally designated 100. The wire strand 100 includes a central wire 102 and six outer wires 104 surrounding the central wire 102.

A cavity 106 is formed between the central wire 102 and each two adjacent outer wires 104. A hypothetical or imaginary circle 108 may be inscribed in this cavity 106, which contacts all three wires 102-104-104. The diameter of this circle 108, shown as dotted circle in FIG. 1, is denoted D1 in FIG. 1. At least one of the cavities 106 may be used to receive an optical fiber 110. At the left side of FIG. 1, at the same level as the circle 108, an optical fiber is shown for merely explanatory reasons. In particular, it is shown that the optical fiber 110, in a state not received in the cavity 106 and therefore undeformed state, has a diameter D2 which is greater than the diameter D1 of the imaginary circle 108. For this and merely explanatory reasons, the outline of the optical fiber 110 is shown to intersect the outlines of the wires 102 and 104.

The actual installed state of the optical fiber 110 is shown centered between the undeformed fiber 110 (left) and the imaginary circle 108 (right). As is shown, the clamping forces of the wires 102, 104 have deformed the outer surface of the optical fiber 110 so that the optical fiber 110 is securely held between the wires.

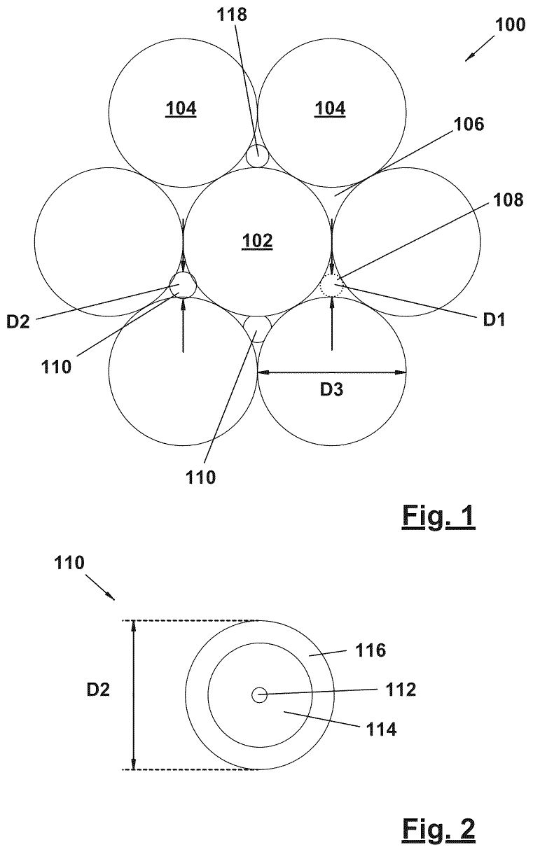

As shown in FIG. 2, the optical fiber 110 includes a fiber core 112 and at least one further layer surrounding the fiber core 112. In the illustrated embodiment, two further layers are provided, namely a layer 114 directly surrounding the fiber core 112, which may for example be formed from a polyacrylate, and an outer (protective) layer 116, which may for example be formed from a metal, preferably steel.

As the inventors have recognized, by simply clamping the optical fiber 110 between the wires 102, 104, i.e., without using any additional adhesive, it is possible to achieve that, on the one hand, the fiber is mechanically connected to the wires 102, 104 so tightly that it can provide information about their state of elongation and thus also about the state of the concrete structure, but that, on the other hand, the fiber core 112 is not subjected to in 5 such high pressure that its light conduction properties and thus the function of the optical fiber 110 as a whole would be compromised. It is to the credit of the inventors to have recognized that this objective can be achieved, in particular, if the ratio of the outer diameter D2 of the optical fiber 110 to the diameter D3 of an outer wire 104 is at least about 0.15 and at most about 0.18, preferably at least about 0.16 and at most about 0.17, more preferably at least about 0.163 and at most about 0.169.

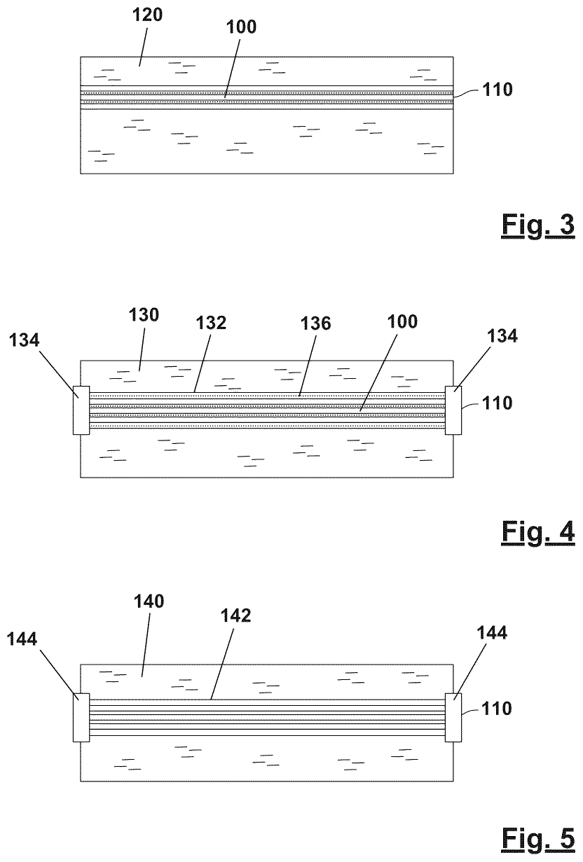

FIG. 3 shows a schematic representation of a pre-stressed concrete structure 120 according to the invention.

In this pre-stressed concrete structure 120, a plurality of pre-stressed strands is embedded directly in the concrete, at least one of these strands being a strand 100 according to the invention with an optical fiber 110. After curing of the concrete, the strands may remain in the concrete without anchoring by a mechanical anchorage. In this case, the optical fiber 110 can be led out of the strand 100 according to the invention in a simple manner at one of its ends and fed to a measuring apparatus (not shown).

FIG. 4 shows a schematic representation of a post-tensioned concrete structure 130 according to the invention.

In this post-tensioned concrete structure 130, a sheathing tube 132 is embedded in the concrete, into which a plurality of strands can be drawn after or before curing of the concrete, including at least one strand 100 according to the invention. After tensioning the strands and anchoring same by means of mechanical anchorages 134, the interior of the sheathing tube 132 remaining between the strands is filled with grout 136. After hardening, this provides the necessary bond between the strands and the surrounding concrete of the post-tensioned concrete structure 130.

According to FIG. 5, showing the example of an unbonded concrete structure 140, it is also conceivable in accordance with the invention to omit the step of filling the cladding tube 142 there with grout. In this case, at least the overall condition of the unbonded concrete structure 140 between the anchorages 144 can be detected by means of the strand 100 provided with the optical fiber 110.

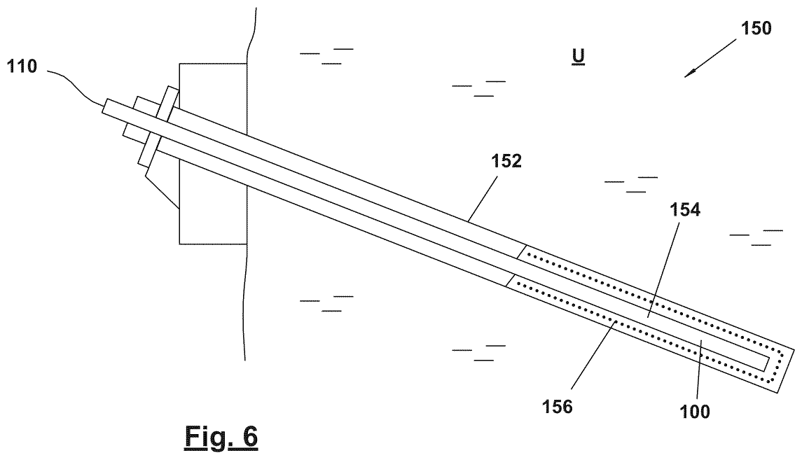

Finally, FIG. 6 shows a schematic representation of a geotechnical strand anchor 150 according to the invention. For the installation of this anchor 150, a borehole 152 is made in the underground U in a manner known per se. The anchor 150 is inserted into this borehole 152. Tthe tensioning element 154 of the anchor 150 comprises a plurality of strands, including at least one strand 100 according to the invention comprising an optical fiber 110. Grout 156 is then filled into a portion of the borehole 152, which, after curing, holds the anchor 150 in the borehole 152. Outside the borehole 152, the anchor 150 can then be tensioned in a manner known per se. In this process, the optical fiber 110 is fed out of the anchor 150 at the free end of the tensioning element 154 of the anchor 150 and fed to a measuring apparatus (not shown).

It is to be added that in addition to the optical fiber 110 intended for strain measurement, another optical fiber 118 can be provided (see FIG. 1), which can be used as a temperature sensor. This temperature measuring fiber 118 preferably does not have a metal cladding, but is in contact with the wires 102, 104 only via a gel in order to mechanically decouple it from the latter.

It should further be added that two methods are conceivable for inserting the fiber 110 and optionally the fiber 118 into the strand 100.

According to a first method, in a first step one of the outer wires 104 is removed from the strand 100. Subsequently, in a second step, the optical fiber 110 is inserted. Finally, the previously removed wire is added back to in 5 the strand 100 in a third step.

According to a second method, the strand 100 is spliced between two clamping jaws. The optical fiber 110 then is inserted into the strand 100 through the gap created thereby. Further, the splice is allowed to travel continuously along the length of the strand 100 or the strand 100 is allowed to travel continuously thorough the splicing device.

Below specific values for three embodiments are shown. Examples 1 and 2 resulted in measurements which were meaningful for the strain of the concrete structure, while the negative example resulted in unsuable measurements.

### Example 1

D1=0.811 mm
D2=0.85 mm
D3=5.20 mm
D2/D3=0.163
D_{fiber core}=0.82 μm
D_{core wire}=5.36 mm

### Example 2

D1=0.808 mm
D2=0.85 mm
D3=5.17 mm
D2/D3=0.169
d_{fiber core}=0.82 μm
d_{core wire}=5.32 mm

### Negative Example

D1=0.640 mm
D2=0.85 mm
D3=4.10 mm
D2/D3=0.208
d_{fiber core}=0.82 μm
d_{core wire}=4.22 mm

1. A wire strand comprising at least three wires,
wherein an optical fiber is arranged in a cavity between three adjacent ones of the at least three wires which optical fiber comprises a fiber core and at least one further layer surrounding the fiber core,
wherein a diameter of a largest imaginary circle inscribable in a cross-section of the cavity is smaller than an outer diameter of the optical fiber,
wherein a diameter of the fiber core is smaller than the diameter of said largest imaginary circle, and
wherein a ratio of the outer diameter of the optical fiber to a diameter of that one of the three adjacent wires which has a smallest diameter is at least about 0.15 and at most about 0.18.

2. The wire strand according to claim 1, wherein a Young's modulus of the material from which the at least one further layer is formed amounts to between about 1,000 MPa and about 210,000 MPa.

3. The wire strand according to claim 1, wherein at least one of the at least one further layer surrounding the fiber core is formed from a polyacrylate.

4. The wire strand according to claim 1, wherein at least one of the at least one further layer surrounding the fiber core is formed of metal.

5. The wire strand according to claim 4, wherein a standard potential of the metal of the at least one further layer surrounding the fiber core is lower than or equal to a standard potential of the wires of the strand.

6. The wire strand according to claim 1, further comprising a center wire and a plurality of outer wires wires wherein at least six of the outer wires are contacting the center wire.

7. The wire strand according to claim 1, further comprising a further optical fiber arranged in a further cavity formed by the center wire and two adjacent outer wires, wherein at least one further layer surrounding the fiber core of the further optical fiber is formed by a gel.

8. The wire strand according to claim 1, wherein a ratio of the outer diameter of the optical fiber to the diameter of that one of the three adjacent wires which has the smallest diameter is at least about 0.16 and at most about 0.17.

9. A tensioning cable including at least one wire strand according to claim 1.

10. A geotechnical anchor including at least one wire strand according to claim 1.

11. A concrete structure including at least one tensioning cable according to claim 9.

12. A concrete structure according to claim 11, wherein said concrete structure is made from pre-stressed concrete and/or post-tensioned concrete.

13. A concrete structure including at least one wire strand according to claim 1.
